(19) United States
(12) Patent Application Publication
(10) Pub. No.: US 2025/0100881 A1
(43) Pub. Date: Mar. 27, 2025

(54) RECYCLING SYSTEM AND METHOD FOR WASTE SULFURIC ACID SOLUTION CONTAINING HYDROGEN PEROXIDE

(71) Applicant: MEGA UNION TECHNOLOGY INCORPORATED, Taoyuan City (TW)

(72) Inventors: KUO-CHING LIN, Taoyuan City (TW); SHR-HAN SHIU, Taoyuan City (TW); YI-SYUAN HUANG, Taoyuan City (TW)

(21) Appl. No.: 18/891,730

(22) Filed: Sep. 20, 2024

(30) Foreign Application Priority Data
Sep. 22, 2023 (TW) 112136356

(51) Int. Cl. C01B 17/90; C01B 17/88

(52) U.S. Cl. CPC C01B 17/90; C01B 17/88

(57) ABSTRACT

A recycling system and method for treating waste sulfuric acid solution containing hydrogen peroxide are provided. The recycling system includes a preheat subsystem, a reaction cycle control subsystem, and a cooling subsystem. The preheat subsystem heats the waste sulfuric acid solution to a target temperature through a cyclic heat exchange method and then further raises the temperature using an acid-resistant heater. The reaction cycle control subsystem monitors the sulfuric acid concentration, hydrogen peroxide content, reaction temperature, and nitrate compound content of the waste sulfuric acid solution to determine the amount and mode of addition of a nitrate-containing promoter. The cooling subsystem includes a first cooling heat exchanger to transfer waste heat to the initial waste sulfuric acid solution and a second cooling heat exchanger to reduce the sulfuric acid to a safe temperature, thereby avoiding overheating.

### 1. FIELD OF THE INVENTION

The present invention relates to a system and a method for recycling waste claim fluid, particularly to a waste sulfuric acid solution containing hydrogen peroxide.

### 2. DESCRIPTION OF THE PRIOR ART

Hydrochloric acid is used as a promoter to decompose hydrogen peroxide in existing processes, with a reaction time of approximately 11 hours. Since the treatment of waste sulfuric acid solution and the reaction with the catalyst is an exothermic reaction, the excessively high processing temperatures may lead to industrial safety concerns, such as explosions. Additionally, the existing processes have low recovery rates and poor recovery qualities, which fail to ensure that the treated waste sulfuric acid solution meets the required standards. Therefore, the waste solution cannot be reused and is often disposed of as waste.

### 3. SUMMARY OF THE INVENTION

In view of the foregoing, the inventors of the present disclosure thought about and designed a waste sulfuric acid waste liquid recovery system in order to improve the deficiencies of the existing processes and solve the Industrial problems.

In order to solve the above problem, the present disclosure provides a system for recycling waste sulfuric acid solution, by adding nitric acid and using cyclic heat exchange mode, thereby enhancing reaction efficiency, ensuring recovery quality, and preventing excessively high temperatures during the treatment process.

The present disclosure provides a recycling system for treating waste sulfuric acid solution containing hydrogen peroxide, includes a preheat subsystem, a reaction cycle control system, a cooling subsystem, and a sulfuric acid storage tank. The preheat subsystem includes a preheat waste sulfuric acid solution storage tank and an acid-resistant heater. The preheat waste sulfuric acid solution storage tank is connected to the acid-resistant heater. The reaction cycle control system includes a reaction tank connected to the acid-resistant heater. The reaction tank is configured to receive a promoter. The cooling subsystem includes a first cooling heat exchanger and a second cooling heat exchanger. One end of the first cooling heat exchanger is connected to the reaction tank and another end is connected to the second cooling heat exchanger. The sulfuric acid storage tank is connected to the second cooling heat exchanger. An initial waste sulfuric acid solution is injected from a supply source of waste sulfuric acid solution into the preheat subsystem, flows through the reaction cycle control system and reacts with the promoter to form a sulfuric acid solution, and then flows through the cooling subsystem to be processed into a recovered sulfuric acid solution, which is stored in the sulfuric acid storage tank.

Preferably, the preheat waste sulfuric acid solution storage tank is configured to initially heat the injected initial waste sulfuric acid solution to a preheat temperature of 50° C. to 60° C., and then flows into the acid-resistant heater which is configured to heat to a target temperature of 70° C. to 80° C.

Preferably, the recycling system for waste sulfuric acid solution containing hydrogen peroxide further includes a first cooling exchange pipelin. The first cooling exchange pipeline connects the supply source of the waste sulfuric acid solution and extends through an exterior of the first cooling heat exchanger to the preheat waste sulfuric acid solution tank, such that the sulfuric acid solution inside the first cooling heat exchanger is cooled by circulating the initial waste sulfuric acid solution at room temperature through the first cooling exchange pipeline.

Preferably, the recycling system for waste sulfuric acid solution containing hydrogen peroxide further includes a second cooling exchange pipeline. The second cooling exchange pipeline connects the cooling water supply source and extends through the exterior of the second cooling heat exchanger, such that the second cooling heat exchanger cools the sulfuric acid solution to a recovery temperature using the cooling water, thereby forming the recovered sulfuric acid solution.

Preferably, the recycling system for waste sulfuric acid solution containing hydrogen peroxide further includes a heat exchange pipeline. The heat exchange pipeline connects the first cooling heat exchanger and extends through the exterior of the preheat waste sulfuric acid solution storage tank to the second cooling heat exchanger, such that the initial waste sulfuric acid solution inside the preheat waste sulfuric acid solution storage tank is heated by the high-temperature sulfuric acid solution circulating through the heat exchange pipeline.

Preferably, the recycling system for waste sulfuric acid solution containing hydrogen peroxide further includes a detection device. The detection device is connected to the reaction tank and is configured to monitor a sulfuric acid concentration, a hydrogen peroxide content, a reaction temperature, and a nitrate compound content of the waste sulfuric acid solution and is configured to determine an amount and an addition mode of the promoter.

Preferably, the addition mode includes a first mode and/or a second mode, in the first mode, the heated initial waste sulfuric acid solution and the promoter are simultaneously injected into the reaction tank for the reaction, in the second mode, the heated initial waste sulfuric acid solution is first injected to a certain liquid level, and the promoter is then added to the reaction tank for the reaction.

Preferably, the promoter is a nitrate-based additive.

Preferably, the sulfuric acid concentration in the waste sulfuric acid solution is greater than 55 wt. %, and the hydrogen peroxide concentration in the waste sulfuric acid solution is below 10 wt. %. Preferably, the allowable residual amount of hydrogen peroxide in the sulfuric acid solution is below 30 ppm, and the allowable residual amount of nitric acid is between 200-400 ppm.

Preferably, the recycling system for waste sulfuric acid solution containing hydrogen peroxide further including at least one backup recycling system for waste sulfuric acid solution, wherein the backup recycling system includes a backup preheat subsystem, a backup reaction cycle control subsystem, and a backup cooling subsystem, the backup recycling system is configured to circulate and cool overheated sulfuric acid solutions or serve as a backup system.

Preferably, the backup preheat subsystem is connected to the reaction cycle control subsystem, and the preheat subsystem is connected to the backup reaction cycle control subsystem.

The present disclosure also provides a method of recycling the waste sulfuric acid solution containing hydrogen peroxide. The method includes injecting an initial waste sulfuric acid solution containing hydrogen peroxide from a supply source of the waste sulfuric acid solution into a preheat waste sulfuric acid solution storage tank of a preheat subsystem, the initial waste sulfuric acid solution is heated to a preheat temperature via cyclic heat exchange and is then heated to a target temperature using an acid-resistant heater of the preheat subsystem; injecting the heated initial waste sulfuric acid solution into a reaction tank of a reaction cycle control subsystem, and adding a promoter to the reaction tank to form a sulfuric acid solution; and injecting the sulfuric acid solution into a first cooling heat exchanger of the cooling subsystem to be cooled by the initial waste sulfuric acid solution at room temperature through circulation, and further cooling the sulfuric acid solution to a recovery temperature using cooling water in a second cooling heat exchanger, thereby forming a recovered sulfuric acid solution.

Preferably, the method further includes connecting the sulfuric acid supply source to a first cooling exchange pipeline, which extends through an exterior of the first cooling heat exchanger before connecting to the preheat sulfuric acid tank, such that the sulfuric acid solution inside the first cooling heat exchanger is cooled by circulating the low-temperature initial waste sulfuric acid solution through the first cooling exchange pipeline.

Preferably, the method further includes connecting the first cooling heat exchanger to a heat exchange pipeline, which extends through the exterior of the preheat waste sulfuric acid solution storage tank before connecting to the second cooling heat exchanger, such that the initial waste sulfuric acid solution inside the preheat waste sulfuric acid solution tank is heated by circulating the high-temperature sulfuric acid solution through the heat exchange pipeline.

Preferably, the method further includes connecting at least one backup recycling system for waste sulfuric acid solution to the sulfuric acid supply source, wherein a backup preheat subsystem of the backup recycling system for waste sulfuric acid solution is connected to the reaction cycle control subsystem, and the backup reaction cycle control subsystem of the backup recycling system for waste sulfuric acid solution is connected to the preheat subsystem, such that the backup recycling system is configured to circulating and cool an overheated sulfuric acid solutions or serve as a backup system.

### 4. BRIEF DESCRIPTION OF THE DRAWINGS

Implementations of the present disclosure will now be described, by way of embodiment, with reference to the attached figures.

FIG. 1 is a schematic view showing an embodiment of the recycling system for treating waste sulfuric acid solution containing hydrogen peroxide of the present disclosure.

FIG. 2 is a schematic view showing an embodiment of the recycling system for treating waste sulfuric acid solution containing hydrogen peroxide of the present disclosure.

FIG. 3 is a flowchart of an embodiment of a recycling method for treating waste sulfuric acid solution containing hydrogen peroxide of the present disclosure.

### 5. DESCRIPTION OF THE PREFERRED EMBODIMENT

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents, as can be included within the spirit and scope of the described embodiments, as defined by the appended claims. Thereinafter, the implementation invention and the related embodiment will be described to illustrate the characteristics of the present invention. However, the embodiment well known by the persons skilled in that art may not be specifically described in the specification.

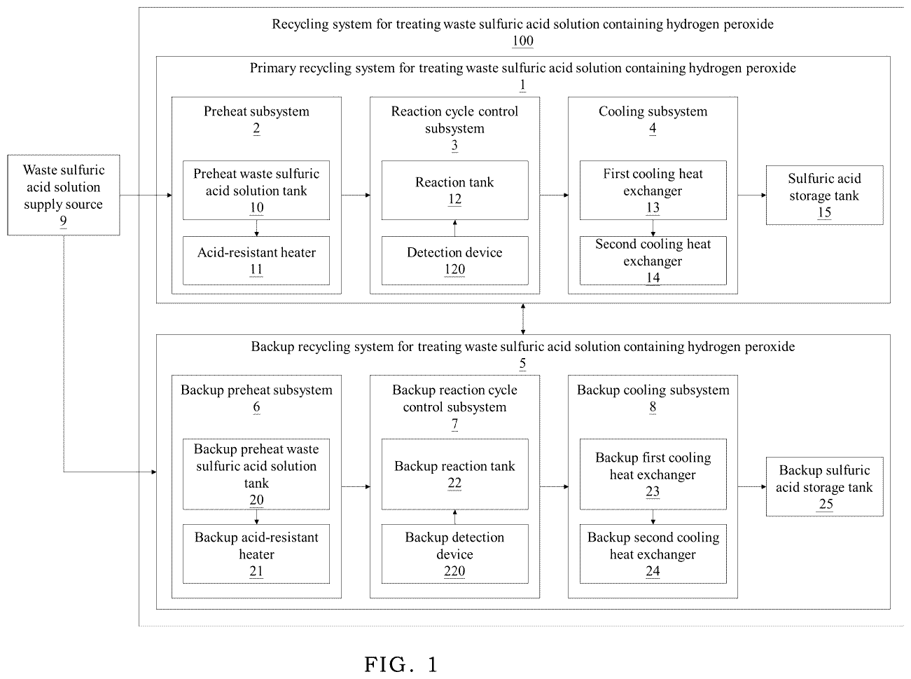

Refer to FIG. 1, which is a schematic view showing an embodiment of the recycling system for treating waste sulfuric acid solution containing hydrogen peroxide according to the present disclosure. As shown in FIG. 1, the recycling system for treating waste sulfuric acid solution containing hydrogen peroxide 100 of the present disclosure includes a primary recycling system for treating waste sulfuric acid solution containing hydrogen peroxide 1 and at least one backup recycling system for treating waste sulfuric acid solution containing hydrogen peroxide 5. The primary recycling system for treating waste sulfuric acid solution containing hydrogen peroxide 1 includes a preheat subsystem 2, a reaction cycle control subsystem 3, and a cooling subsystem 4. The backup recycling system for treating waste sulfuric acid solution containing hydrogen peroxide 5 includes a backup preheat subsystem 6, a backup reaction cycle control subsystem 7, and a backup cooling subsystem 8. For simplicity of explanation, the present invention is exemplified with a single backup waste sulfuric acid solution recycling system as described above, it shall be understood that it is used as an example and not to limit the present disclosure, the number of backup cooling subsystem of the present disclosure can be implemented in two, three, or more.

The preheat subsystem 2 includes a preheat waste sulfuric acid solution tank 10 and an acid-resistant heater 11. The preheat waste sulfuric acid solution tank 10 is connected to the acid-resistant heater 11. The backup preheat subsystem 6 includes a backup preheat waste sulfuric acid solution tank 20 and a backup acid-resistant heater 21. The backup preheat waste sulfuric acid solution tank 20 is connected to the backup acid-resistant heater 21.

The reaction cycle control subsystem 3 includes a reaction tank 12. The reaction tank 12 is connected to the acid-resistant heater 11 and further connected to a detection device 120. The backup reaction cycle control subsystem 7 includes a backup reaction tank 22. The backup reaction tank 22 is connected to the backup acid-resistant heater 23. The backup reaction tank 22 is also connected to a backup detection device 220.

The cooling subsystem 4 includes a first cooling heat exchanger 13 and a second cooling heat exchanger 14. One end of the first cooling heat exchanger 13 is connected to the reaction tank 12, and the other end is connected to the second cooling heat exchanger 14. A sulfuric acid storage tank 15 is connected to the second cooling heat exchanger 14. The backup cooling subsystem 8 includes a backup first cooling heat exchanger 23 and a backup second cooling heat exchanger 24. One end of the backup first cooling heat exchanger 23 is connected to the backup reaction tank 22, and the other end is connected to the backup second cooling heat exchanger 24. A backup sulfuric acid storage tank 25 is connected to the backup second cooling heat exchanger 24.

In order to determine the amount and addition mode of the promoter, the detection device 120 and the backup detection device 220 monitor the sulfuric acid concentration of the waste sulfuric acid solution using specific gravity method, detect the hydrogen peroxide content using titration methods, detect the nitrate compound content using spectrophotometric methods, measure the reaction temperature by thermometers. The initial waste sulfuric acid solution has a sulfuric acid concentration greater than 55 wt. %, a hydrogen peroxide concentration below 10 wt. % or between 2-6 wt. %, and a nitric acid concentration of approximately 500-600 ppm. The detection device 120 and the backup detection device 220 adjust the amount and addition mode of the promoter until the final sulfuric acid solution has a sulfuric acid concentration of 55 wt. % to 85 wt. %, and a hydrogen peroxide concentration below 30 ppm, and a nitric acid concentration below 200-400 ppm.

Refer to FIG. 1, an initial waste sulfuric acid solution is injected from a waste sulfuric acid solution supply source 9 into the preheat subsystem 2, is heated and flows through the reaction cycle control subsystem 3 to form a sulfuric acid solution, and then is cooled by flowing through the cooling subsystem 4 and is stored as a recovered sulfuric acid solution in the sulfuric acid storage tank 15. Alternatively, the initial waste sulfuric acid solution can be injected from the waste sulfuric acid solution supply source 9 into the backup preheat subsystem 6, heated, and then flows through the backup reaction cycle control subsystem 7 to form a sulfuric acid solution, and then flows through the backup cooling subsystem 8 to be cooled and stored as a recovered sulfuric acid solution in the backup sulfuric acid storage tank 25.

Furthermore, the backup waste sulfuric acid solution recycling system 5 may circulate and cool the overheated sulfuric acid solution from the primary waste sulfuric acid solution recycling system 1 or serve as a backup system.

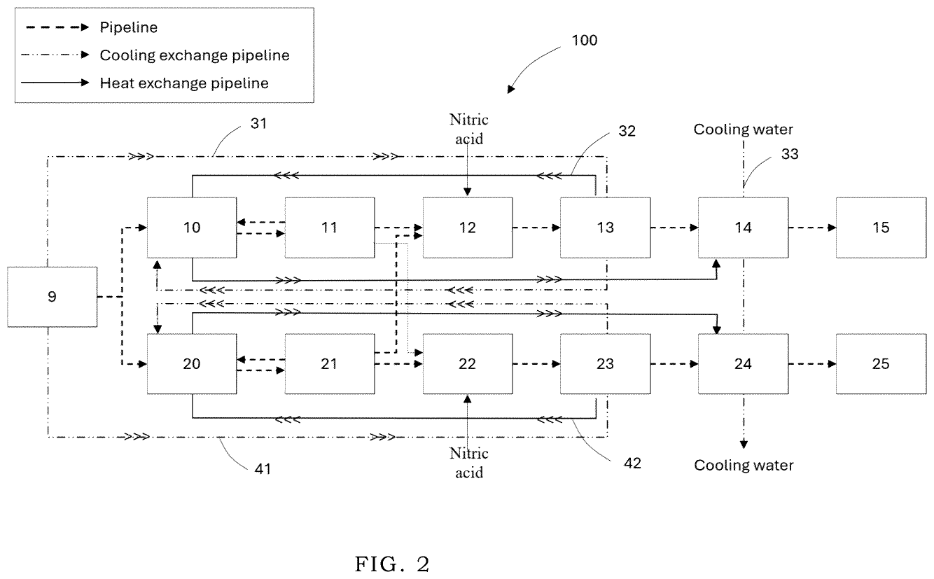

Refer to FIG. 2, the primary recycling system for treating the waste sulfuric acid solution containing hydrogen peroxide 1 of the present disclosure injects an initial waste sulfuric acid solution containing hydrogen peroxide (i.e., the waste acid to be processed) from the waste sulfuric acid solution supply source 9 into the preheat waste sulfuric acid solution tank 10 at room temperature. Then the initial waste sulfuric acid solution is heated to a target temperature of 80° C. by flowing into the acid-resistant heater 11. The heated waste sulfuric acid solution flows into the reaction tank 12. A promoter is also added in the reaction tank 12. Since hydrogen peroxide will instantly release reaction heat during the reaction, while temperature is rising rapidly, the injection of the lower-temperature waste sulfuric acid solution can slow down the rise of the temperature.

After the reaction, the first cooling heat exchanger recovers the heat from the high-temperature sulfuric acid solution. The first cooling heat exchanger 13 is connected to a heat exchange pipeline 32, allowing the high-temperature sulfuric acid solution to circulate through the heat exchange pipeline 32 and flow through an exterior of the preheat waste sulfuric acid solution tank 10. The high-temperature sulfuric acid solution heats the room-temperature waste sulfuric acid solution waste liquid in the preheat waste sulfuric acid solution storage tank 10 to the preheating temperature (50° C.˜60° C.) to achieve temperature equilibrium, thereby reducing the preheating time, and cooling down the high-temperature sulfuric acid in the heat exchange pipeline 32 by heat exchange. The heat exchange pipeline 32 and the first cooling heat exchanger 13 then inject the cooled sulfuric acid solution into the second cooling heat exchanger 14 for further cooling.

The cooling water is injected into the second cooling pipeline 33 and flowing through an exterior of the second cooling heat exchanger 14, so that the high-temperature sulfuric acid solution inside the second cooling heat exchanger 14 is cooled to a recovery temperature. Then the recovered sulfuric acid solution is injected into the sulfuric acid storage tank 15 for storage.

When the temperature of the sulfuric acid solution inside the first cooling heat exchanger 13 becomes excessively high, the waste sulfuric acid solution supply source 9 connects to the first cooling pipeline 31, allowing the room-temperature initial waste sulfuric acid solution circulates through an exterior of the first cooling heat exchanger 13 via the first cooling pipeline 31, cooling the overheated sulfuric acid solution inside the first cooling heat exchanger 13 to balance the temperature. Meanwhile, the initial waste sulfuric acid solution inside the first cooling pipeline 31 is heated by heat exchange and injected into the preheat waste sulfuric acid solution tank 10. Therefore, the residual heat generated from the reacted sulfuric acid solution is fully used to reduce energy consumption and costs associated with heating and cooling, which achieves energy conservation and carbon reduction.

In addition, the recycling system for treating waste sulfuric acid solution containing hydrogen peroxide 100 is designed with at least two production lines, i.e. the primary waste sulfuric acid solution recycling system 1 and at least one backup waste sulfuric acid solution recycling system 5. Therefore, when the temperature of one of the production lines becomes excessively high, it can be circulated to the second production line which is used as a backup production line for cooling, thereby preventing production line shutdown due to failure.

Specifically, the acid-resistant heater 11 is further connected to the backup reaction tank 22, and the backup acid-resistant heater 21 is further connected to the reaction tank 12. When the reaction tank 12 of the primary production line becomes overheated or shutdown, the waste sulfuric acid solution inside the acid-resistant heater 11 can flow to the backup reaction tank 22, and vice versa, thereby preventing production shutdown due to overheating to failure.

In addition, when there are more than one backup production line, production stoppage due to overheating or shutdown can be prevented, and recovery capacity and efficiency can be improved.

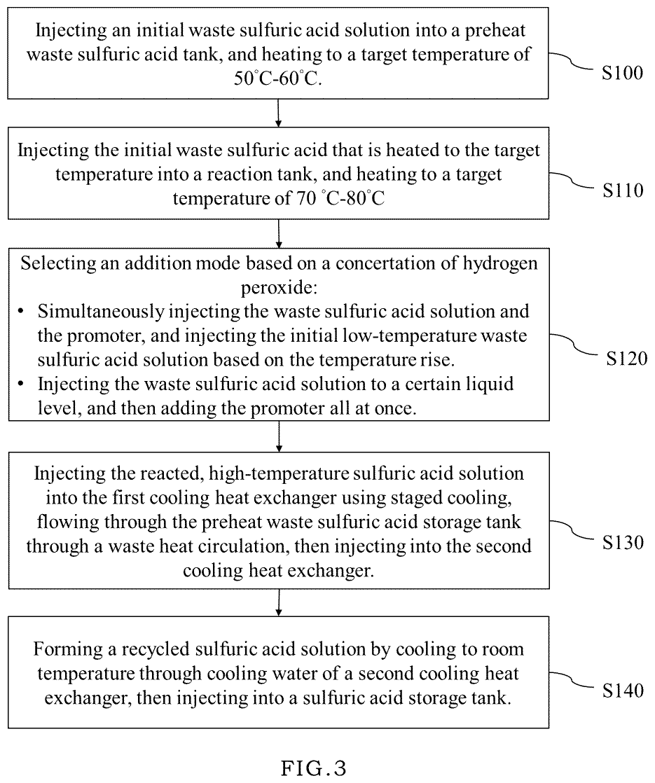

Refer to FIG. 3, is a flowchart of recycling method of waste sulfuric acid solution containing hydrogen peroxide.

Refer to FIG. 3, in step S100, the initial waste sulfuric acid solution to be processed is injected into the preheat waste sulfuric acid solution tank 10, and is heated to the preheating temperature to 50° C. ˜60° C.

In step S110, the initial waste sulfuric acid solution is directly heated by the acid-resistant heater 11 to raise the temperature of the initial waste sulfuric acid solution inside the acid-resistant heater 11 to the target temperature of 70-80° C., and then the heated waste sulfuric acid solution injected it into the reaction tank 12. In step S120, the recycling system for treating waste sulfuric acid solution containing hydrogen peroxide 100 sets the processing time based on the temperature and hydrogen peroxide concentration of the waste sulfuric acid solution in the reaction tank 12, calculates the amount of the promoter to be added, and determines the addition mode based on the sulfuric acid concentration. The detection device 120 in the reaction tank 12 monitors whether the system temperature exceeds a safety value and controls the transportation of the waste sulfuric acid solution to the first cooling heat exchanger 13. In step S130, circulation is performed to control the waste sulfuric acid solution to below 90° C. In step S140, the room-temperature waste sulfuric acid solution is recovered and injected into the sulfuric acid storage tank 15.

When the reaction process reaches equilibrium, the addition mode of the reaction promoter is determined based on the hydrogen peroxide concentration. The first addition mode simultaneously adds the waste sulfuric acid solution and the promoter, while the second addition mode adds the waste sulfuric acid solution to a certain liquid level first, and then adds the promoter for the reaction.

The first addition mode simultaneously injects the waste sulfuric acid solution and the promoter, the advantage of which is the acceleration of the reaction time.

The second addition mode injects nitric acid first, and then adds the promoter at once for the reaction, the advantage of which is better control of the amount of the promoter.

The concentration of hydrogen peroxide and temperature during the reaction is inversely proportional. The sulfuric acid concentration needs to be at least greater than 55%. The present disclosure can adjust the initial reaction temperature based on the initial temperature of the reaction tank 12, the sulfuric acid concentration of the waste sulfuric acid solution, and the hydrogen peroxide concentration, keeping the maximum temperature below 100° C. during the process, thereby reducing the hydrogen peroxide concentration to 1%, ensuring recovery quality, processing efficiency, recovery rate, and preventing excessively high temperatures.

The following table compares different promoters to determine the recovery time and temperature rise required for the recycling system for treating waste sulfuric acid solution containing hydrogen peroxide of the present disclosure, where the comparative example uses hydrochloric acid as the promoter, while the embodiment uses nitric acid as the promoter.

Comparative example: efficiency of recovering waste sulfuric acid solution using hydrochloric acid.

TABLE 1

| | | Test | |
|---|---|---|---|
| | | 1 | 2 |
| Initial | Volume of waste sulfuric acid (m³) | 5 | 5 |
| parameters | Concentration of waste sulfuric acid (wt. | 50 | 55 |
| | %) | | |
| | Concentration of hydrogen peroxide (wt. | 5 | 3 |
| | %) | | |
| | Initial reaction temperature of waste | 35~40 | 35~40 |
| | sulfuric acid (° C.) | | |
| | Amount of promoter (L) | 0.5 | 4 |
| Final | Final concentration of hydrogen peroxide | <30 | <30 |
| parameters | (ppm) | | |
| | Final concentration of promoter (ppm) | <50 | <50 |
| | Final temperature of waste sulfuric acid | 80~90 | <75 |
| | (° C.) | | |
| | Reaction time (hr.) | 20 | 20 |

As shown in Table 1, when the reaction process in the system is nearing completion, the concentrations of hydrogen peroxide and the reaction promoter in the system are low. The final temperature of the waste sulfuric acid solution is the main factor determining the reaction time. In the present comparative example, when the initial concentration of hydrogen peroxide in the waste sulfuric acid solution is 3 wt. %, the final temperature of the waste sulfuric acid solution does not reach 75° C. However, when the initial concentration of hydrogen peroxide in the waste sulfuric acid solution is 5 wt. %, the final temperature of the waste sulfuric acid solution rises to 80-90° C., and the time required for the reaction to reach a hydrogen peroxide concentration of less than 30 ppm is 20 hours, which is highly inefficient.

Embodiment: temperature rise conditions during the decomposition of hydrogen peroxide in waste sulfuric acid solution.

TABLE 2

| | Decomposition concentration of hydrogen | | | | | |
|---|---|---|---|---|---|---|
| | peroxide (wt. %) | | | | | |
| | 1.0 | 2.0 | 3.0 | 4.0 | 5 | 6 |
| Min temperature (° C.) | 90 | 100 | 110 | 120 | 130 | 140 |
| Max temperature (° C.) | 93.7 | 107.4 | 121.1 | 134.8 | 148.5 | 162.2 |

As shown in Table 2, the cumulative temperature rise for each 1.0 wt. % of hydrogen peroxide removed from the waste sulfuric acid solution is detailed. According to the calculation of decomposition heat of hydrogen peroxide, the decomposition of each 1 wt. % of hydrogen peroxide raises the temperature of the mixed solution of waste sulfuric acid solution and the promoter by 13.7° C. The actual temperature rise will be affected by environmental heat dissipation factors, with the actual temperature rise being approximately 10-13.7° C. Factors affecting temperature change may include weather, insulation methods, and the overall reaction time.

If the initial reaction temperature is 80° C. and the initial hydrogen peroxide concentration is 6.0%, it is estimated that the normal decomposition of hydrogen peroxide can provide a maximum temperature rise of 82.2° C., resulting in a final system temperature of 80+82.2=152.2° C. The high temperature will affect the lifetime of various equipment and components of the waste sulfuric acid solution recycling system. Therefore, when the concentration of hydrogen peroxide is high, the control point of safe cooling cycle temperature must be lowered to ensure the temperature of the final reaction sulfuric acid is less than 40° C.

Additionally, for high-concentration waste sulfuric acid solution (greater than or equal to 55 wt. %), using intermittent addition of the promoter and stirring can improve reaction efficiency, but it is not applicable to low-concentration waste sulfuric acid solution (less than 55 wt. %). Therefore, it is recommended to increase the system sulfuric acid concentration greater than or equal to 55% for better reaction efficiency.

Embodiment 2: efficiency of recovering waste sulfuric acid solution using nitric acid.

TABLE 3

| | | Test | | | |
|---|---|---|---|---|---|
| | | 1 | 2 | 3 | 4 |
| Initial | Volume of waste sulfuric acid (m³) | 2.5 | 2.5 | 2.5 | 2.5 |
| parameters | Concentration of waste sulfuric acid (wt. %) | 55 | 55 | 55 | 55 |
| | Concentration of hydrogen peroxide (wt. %) | 3.39 | 3.92 | 3.64 | 3.62 |
| | Initial reaction temperature of waste sulfuric acid | 80 | 80 | 60 | 60 |
| | (° C.) | | | | |
| | Amount of promoter (ppm) | 496.6 | 1433.5 | 11,639 | 16,609 |
| Final | Concentration of final hydrogen peroxide (ppm) | 460 | N/A | 780 | N/A |
| parameters | Final concentration of promoter (ppm) | 400 | 1,430 | 790 | 13,200 |
| | Maximum temperature of waste sulfuric acid (° C.) | 89.0 | 113.0 | 62.0 | 110.6 |
| | Reaction time (min) | 10 | <10 | 222 | 106 |

As shown in Table 3, adding nitric acid for hydrogen peroxide catalytic reaction accelerates the overall reaction efficiency, completing the process within a maximum of 222 minutes (i.e. 3.9 hours). Overall, if the reaction promoter is changed to nitric acid, the recovery reaction can be completed more quickly. However, the temperature rise rate is greater, requiring an increase in the initial temperature. The maximum temperature can be reached approximately 113° C. according to the test result. The rapid high-temperature reaction in a short period of time makes the means of temperature control more important.

The recycling system for treating waste sulfuric acid solution containing hydrogen peroxide of the present disclosure can recover waste sulfuric acid solution with a sulfuric acid concentration between 35-80 wt. %, with the hydrogen peroxide concentration in the waste sulfuric acid solution is usually less than 10 wt. %. The recovered sulfuric acid solution is an industrial-grade sulfuric acid solution, with allowable residual amount of hydrogen peroxide is less than 30 ppm and residual amount of nitric acid is between 200-400 ppm.

In summary, the waste sulfuric acid solution processing system of the present disclosure recovers industrial-grade sulfuric acid solution within a set reaction time in the reaction tank. Before injecting the waste sulfuric acid solution into the reaction tank, the system determines whether to preheat and the preheat temperature based on the hydrogen peroxide concentration. An appropriate amount (minimum amount) of the reaction promoter is added, the estimated temperature after the set reaction time (final reaction temperature) is calculated, and the cooling system is activated to control the final temperature (the second cooling heat exchanger) to fall below 40° C. before injecting into the recovery tank to avoid system hazards.

Advantages of the present disclosure: (1) Using a cyclic heat exchange mode, the residual heat from the first cooling heat exchanger 13 is transferred to the initial waste sulfuric acid solution, thereby an additional hot water supply pump as a heater is no required, reducing heating costs; (2) Two-stage cooling: circulating lower-temperature initial waste sulfuric acid solution to the first cooling heat exchanger 13 reduces cooling costs, followed by using the second cooling heat exchanger 14 to bring the temperature down to room temperature; (3) Flexible selection of two addition modes improves reaction efficiency; (4) Two addition modes enhance the controllability of the reaction temperature; (5) Significantly accelerates the reaction process, increasing the recovery capacity of sulfuric acid; (6) Reduces the production of corrosive chlorine gas. Overall, the invention improves reaction efficiency, enhances the recovery quality of sulfuric acid solution, avoids excessively high processing temperatures, reduces heating and cooling costs, and achieves energy conservation and carbon reduction, thereby avoiding safety concerns related to overheating.

What is claimed is:

1. A recycling system for treating waste sulfuric acid solution containing hydrogen peroxide, comprising:
a preheat subsystem comprising a preheat waste sulfuric acid solution storage tank and an acid-resistant heater, wherein the preheat waste sulfuric acid solution storage tank is connected to the acid-resistant heater,
a reaction cycle control system comprising a reaction tank connected to the acid-resistant heater, wherein the reaction tank is configured to receive a promoter,
a cooling subsystem comprising a first cooling heat exchanger and a second cooling heat exchanger, wherein one end of the first cooling heat exchanger is connected to the reaction tank and another end is connected to the second cooling heat exchanger,
a sulfuric acid storage tank connected to the second cooling heat exchanger,
wherein an initial waste sulfuric acid solution is injected from a supply source of waste sulfuric acid solution into the preheat subsystem, flows through the reaction cycle control system and reacts with the promoter to form a sulfuric acid solution, and then flows through the cooling subsystem to be processed into a recovered sulfuric acid solution, which is stored in the sulfuric acid storage tank.

2. The recycling system for treating waste sulfuric acid solution containing hydrogen peroxide according to claim 1, wherein the preheat waste sulfuric acid solution storage tank is configured to initially heat the injected initial waste sulfuric acid solution to a preheat temperature of 50° C. to 60° C., and then flows into the acid-resistant heater which is configured to heat to a target temperature of 70° C. to 80° C.

3. A recycling system for treating waste sulfuric acid solution containing hydrogen peroxide according to claim 1, further comprising a first cooling exchange pipeline, wherein the first cooling exchange pipeline connects the supply source of the waste sulfuric acid solution and extends through an exterior of the first cooling heat exchanger to the preheat waste sulfuric acid solution tank, such that the sulfuric acid solution inside the first cooling heat exchanger is cooled by circulating the initial waste sulfuric acid solution at room temperature through the first cooling exchange pipeline.

4. A recycling system for treating waste sulfuric acid solution containing hydrogen peroxide according to claim 1, further comprising a second cooling exchange pipeline, wherein the second cooling exchange pipeline connects the cooling water supply source and extends through the exterior of the second cooling heat exchanger, such that the second cooling heat exchanger cools the sulfuric acid solution to a recovery temperature using the cooling water, thereby forming the recovered sulfuric acid solution.

5. A recycling system for treating waste sulfuric acid solution containing hydrogen peroxide according to claim 1, further comprising a heat exchange pipeline, wherein the heat exchange pipeline connects the first cooling heat exchanger and extends through the exterior of the preheat waste sulfuric acid solution storage tank to the second cooling heat exchanger, such that the initial waste sulfuric acid solution inside the preheat waste sulfuric acid solution storage tank is heated by the high-temperature sulfuric acid solution circulating through the heat exchange pipeline.

6. A recycling system for treating waste sulfuric acid solution containing hydrogen peroxide according to claim 1, further comprising a detection device, wherein the detection device is connected to the reaction tank and is configured to monitor a sulfuric acid concentration, a hydrogen peroxide content, a reaction temperature, and a nitrate compound content of the waste sulfuric acid solution, and is configured to determine an amount and an addition mode of the promoter.

7. A recycling system for treating waste sulfuric acid solution containing hydrogen peroxide according to claim 6, wherein the addition mode comprises a first mode and/or a second mode, in the first mode, the heated initial waste sulfuric acid solution and the promoter are simultaneously injected into the reaction tank for the reaction, in the second mode, the heated initial waste sulfuric acid solution is first injected to a certain liquid level, and the promoter is then added to the reaction tank for the reaction.

8. A recycling system for treating waste sulfuric acid solution containing hydrogen peroxide according to claim 7, wherein the promoter is a nitrate-based additive.

9. A recycling system for treating waste sulfuric acid solution containing hydrogen peroxide according to claim 1, wherein the sulfuric acid concentration in the waste sulfuric acid solution is greater than 55 wt. %, and the hydrogen peroxide concentration in the waste sulfuric acid solution is below 10 wt. %.

10. A recycling system for treating waste sulfuric acid solution containing hydrogen peroxide according to claim 1, wherein the allowable residual amount of hydrogen peroxide in the sulfuric acid solution is below 30 ppm, and the allowable residual amount of nitric acid is 200-400 ppm.

11. A recycling system for treating waste sulfuric acid solution containing hydrogen peroxide according to claim 1, further comprising at least one backup recycling system for waste sulfuric acid solution, wherein the backup recycling system comprises a backup preheat subsystem, a backup reaction cycle control subsystem, and a backup cooling subsystem, the backup recycling system is configured to circulate and cool overheated sulfuric acid solutions or serve as a backup system.

12. A recycling system for treating waste sulfuric acid solution containing hydrogen peroxide according to claim 1, wherein the backup preheat subsystem is connected to the reaction cycle control subsystem, and the preheat subsystem is connected to the backup reaction cycle control subsystem.

13. A method of recycling waste sulfuric acid solution containing hydrogen peroxide, comprising:
injecting an initial waste sulfuric acid solution containing hydrogen peroxide from a supply source of the waste sulfuric acid solution into a preheat waste sulfuric acid solution storage tank of a preheat subsystem, the initial waste sulfuric acid solution is heated to a preheat temperature via cyclic heat exchange and is then heated to a target temperature using an acid-resistant heater of the preheat subsystem;
injecting the heated initial waste sulfuric acid solution into a reaction tank of a reaction cycle control subsystem, and adding a promoter to the reaction tank to form a sulfuric acid solution; and
injecting the sulfuric acid solution into a first cooling heat exchanger of the cooling subsystem to be cooled by the initial waste sulfuric acid solution at room temperature through circulation, and further cooling the sulfuric acid solution to a recovery temperature using cooling water in a second cooling heat exchanger, thereby forming a recovered sulfuric acid solution.

14. A method according to claim 13, further comprising: connecting the sulfuric acid supply source to a first cooling exchange pipeline, which extends through an exterior of the first cooling heat exchanger before connecting to the preheat sulfuric acid tank, such that the sulfuric acid solution inside the first cooling heat exchanger is cooled by circulating the low-temperature initial waste sulfuric acid solution through the first cooling exchange pipeline.

15. A method according to claim 13, further comprising: connecting the first cooling heat exchanger to a heat exchange pipeline, which extends through the exterior of the preheat waste sulfuric acid solution storage tank before connecting to the second cooling heat exchanger, such that the initial waste sulfuric acid solution inside the preheat waste sulfuric acid solution tank is heated by circulating the high-temperature sulfuric acid solution through the heat exchange pipeline.

16. A method according to claim 13, further comprising: connecting at least one backup recycling system for waste sulfuric acid solution to the sulfuric acid supply source, wherein a backup preheat subsystem of the backup recycling system for waste sulfuric acid solution is connected to the reaction cycle control subsystem, and the backup reaction cycle control subsystem of the backup recycling system for waste sulfuric acid solution is connected to the preheat subsystem, such that the backup recycling system is configured to circulating and cool an overheated sulfuric acid solutions or serve as a backup system.
